(19) United States
(12) Patent Application Publication
(10) Pub. No.: US 2025/0335384 A1
(43) Pub. Date: Oct. 30, 2025

(54) Single Sideband Signals Set for Multi-Port Storage Devices

(71) Applicant: SanDisk Technologies LLC, Austin, TX (US)

(72) Inventors: Julian VLAIKO, Kfar Saba (IL); Shay BENISTY, Beer Sheva (IL); Judah Gamliel HAHN, Ofra (IL); Ariel NAVON, Revava (IL); Alexander BAZARSKY, Holon (IL); Aki BLEYER, Givatayim (IL)

(73) Assignee: SanDisk Technologies LLC, Austin, TX (US)

(21) Appl. No.: 18/644,417

(22) Filed: Apr. 24, 2024

(51) Int. Cl. G06F 13/40; G06F 1/3234

(52) U.S. Cl. CPC G06F 13/4022; G06F 1/3268

(57) ABSTRACT

Rather than having dedicated sideband signal pins for each port in a multi-port data storage device, a single set of sideband signal input pins can be used on a multiplexer (mux) so that the sideband signals can be reused and sent to each port. In so doing, a total number of pins is reduced which leads to a reduced bill of manufacture (BOM) and more available storage space in the data storage device.

### BACKGROUND OF THE DISCLOSURE

### Field of the Disclosure

Embodiments of the present disclosure generally relate to utilizing fewer pins for sideband signals.

### Description of the Related Art

Enterprise solid state devices (SSDs) support nonvolatile memory express (NVMe) dual port features as defined in the NVMe standard and the peripheral component interconnect express (PCIe) standard. Traditionally, single ×4 devices can be split into two ×2 devices via port A and port B. The methods to access the device are either port A as a single port, port B as a single port, or both ports simultaneously as a dual port system. The dual ports provide the ability to connect two host devices simultaneously to a data storage device.

The data storage device can be connected directly to a host device central processing unit (CPU) or via PCIe switch topology if a higher SSD count is necessary. The concept is the same as SAS Enterprise Storage HA designs, but implemented with a PCIe bus.

Dual port NVMe extensions were added to the original specification with NVMe 1.1 revision. The eco-system is new and very focused on addressing specific problems. The problems are common for Enterprise Storage (Scale Up Storage) and some other areas such as high performance computing (HPC) storage. The same concept applies to the automotive storage industry where a multi-port device may be defined and not limited to serving dual host ports. For each host to storage device SSD port, there are at least three side band pins for the interface which take up a lot of storage space and increase costs.

Therefore, there is a need in the art for a multi-port NVMe data storage device that utilizes less storage space while also reducing costs.

### SUMMARY OF THE DISCLOSURE

Rather than having dedicated sideband signal pins for each port in a multi-port data storage device, a single set of sideband signal input pins can be used on a multiplexer (mux) so that the sideband signals can be reused and sent to each port. In so doing, a total number of pins is reduced which leads to a reduced bill of manufacture (BOM) and more available storage space in the data storage device.

In one embodiment, a data storage device comprises: a plurality of memory devices; and a controller coupled to each memory device, wherein the controller comprises: a first plurality of control signal input pins; a second plurality of control signal output pins; and a third plurality of sideband signal input pins, wherein the third plurality is less than the second plurality.

In another embodiment, a data storage device comprises: a memory device; and a controller coupled to the memory device, wherein the controller comprises: a plurality of peripheral component express (PCIe) ports; and a system management bus (SMBus) controller, wherein the SMBus is configured to receive sideband signals from a host device, and wherein the SMBus is configured to provide virtualized sideband signals to each PCIe port of the plurality of PCIe ports.

In another embodiment, a data storage device comprises: means to store data; and a controller coupled to the means to store data, wherein the controller comprises: a time division multiplexer (mux) having “n” number of sideband pins, wherein “n” is an integer, and wherein the mux is configured to switch between 2ⁿ contexts for control signals for data storage device operation.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of a dual port storage controller system.

FIG. 3 is a graph illustrating side band signal timing according to one embodiment.

FIG. 4A is a schematic illustration of a time division multiplexing scheme used for PCIe sideband signals in a multi-port storage device according to one embodiment.

FIG. 4B is a schematic illustration of a time division multiplexing scheme used for PCIe sideband signals in a multi-port storage device according to another embodiment.

FIG. 5 is a schematic illustration of a system management bus (SMBus) interface used for PCIe sideband signals in a multi-port storage device according to one embodiment.

FIG. 6 is a schematic illustration of a system incorporating the embodiments of the disclosure.

FIG. 7 is a flowchart showing a method of delivering sideband signals according to one embodiment.

FIG. 8 is a flowchart showing a method of delivering sideband signals according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Rather than having dedicated sideband signal pins for each port in a multi-port data storage device, a single set of sideband signal input pins can be used on a multiplexer (mux) so that the sideband signals can be reused and sent to each port. In so doing, a total number of pins is reduced which leads to a reduced bill of manufacture (BOM) and more available storage space in the data storage device.

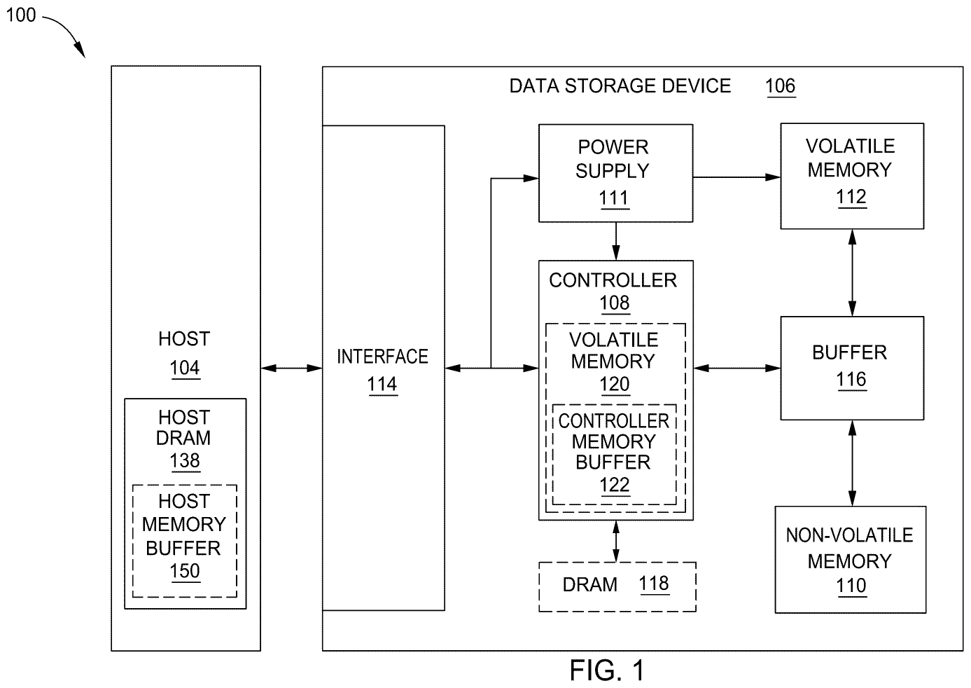

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe ×1, ×4, ×8, ×16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

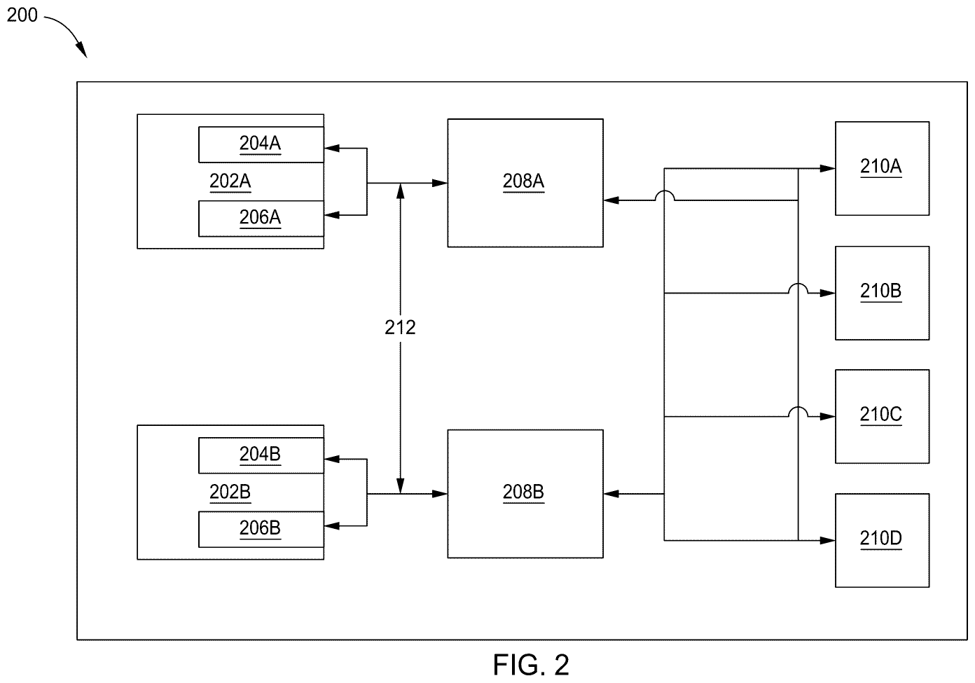

FIG. 2 is a schematic illustration of a dual port storage controller system 200. The system 200 includes two servers 202A, 202B, with each server 202A, 202B having a first host bus adapter (HBA) 204A, 204B and a second HBA 206A, 206B. The system 200 also includes two switches 208A, 208B as well as a plurality of data storage devices 210A-210D. Each data storage device 210A-210D is connected to both switches 208A, 208B. One switch 208A is connected to both the first HBA 204A and the second HBA 206A of the first server 202A. A second switch 208B is connected to both the first HBA 204B and the second HBA 206B of the second server 202B. Furthermore, the connection between the first switch 208A and the second HBA 206A of the first server 202A is connected to the connection between the second switch 208A and the first HBA 204B of the second server 202B as shown by line 212. In the system 200, each data storage device 210A-210D has two ports such that the data storage devices 210A-210D are coupled to two distinct switches 208A, 208B, where the switches 208A, 208B and servers 202A, 202B collectively represent a host device. The system 200 illustrates that two hosts, can be connected to a single data storage device. Furthermore, system 200 illustrates that an individual host device can share at least one, and in some cases multiple, data storage device(s) with at least one other host device.

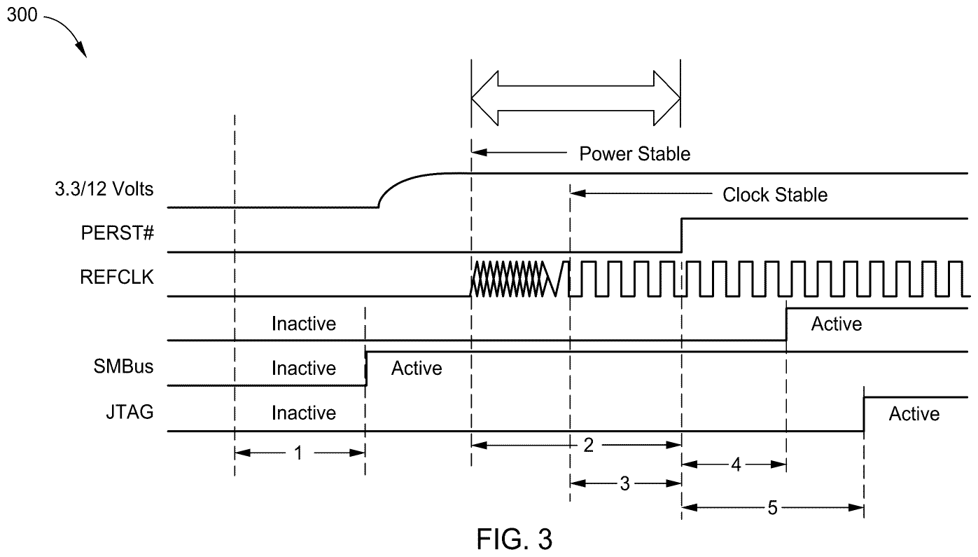

FIG. 3 is a graph illustrating side band signal timing according to one embodiment. The signals shown are inactive for time period 1, but then between time period 1 and time period 2, the power ramps up and the SMBus signal is active. During time period 2, the power stabilizes, and the REFCLK signal begins. The REFCLK signal stabilizes at time period 3. At the beginning of time period 4, the PERST #signal goes active, and at the end of time period 4, another sideband signal goes active. At the end of time period 5, the JTAG signal goes active.

For each host to storage device SSD port, there are at least three side band pins for the interface. Each component of PCIe communication has the following control signals: PERST, WAKE, CLKREQ, and REFCLK. These signals work to generate high-speed signals and communicate with other PCIe devices.

The straightforward solution for a multi-port storage device is to duplicate all PCIe pinouts including the sideband signals per supported port, but the approach is expensive and increases the cost of the device and bill of materials (BOM). It would be beneficial to find a low-cost solution for multi-port data storage device that can work for the automotive industry.

The instant disclosure focuses on how to communicate sideband signals to a data storage device having two, four, or more multi-port storage devices efficiently. In other words, there is provided a new method to reduce the number of pins required for the interface in a multi-port storage device. Multiple devices utilized multiple steps of sideband pins. Here, a single set of sideband pins can be reused with multiple ports. In other words, if there are three sideband signals that use three sideband pins, and there are three data storage devices to access, rather than having three sets of three sideband pins (one for each device), there is just a single set of three sideband pins, and the sideband signals are multiplexed to the three devices.

Discussed herein is a single sideband signal set of pins for managing a multi-port PCIe system, where two, four or more PCIe ports and their connected data storage devices will be managed by a single sideband signal pin set using a time division multiplexing scheme.

The time division multiplexing scheme may be managed by hardware (HW) logic implemented by the storage device controller as follows. A multiplexing control bus built out of one, two or more (n) pins: (1) Redundant side band signals, such as WAKE and power loss acknowledge (PLA); and (2) Vendor Specific Pin Signals.

These n pins control a multiplexer (mux) that switches between 2ⁿ contexts for the control signals required for SSD operation, as per the diagram below describing a set of three signals required for the SSD to operate. REFCLK signal can remain a single signal applicable for all ports, assuming that REFCLK is unique and shared among all ports. Note that the mux might reside on the host device side or the data storage device side. There might be a scenario where a mux is located at both host and device side, essentially embodying a mux/de-multiplexer (demux) in order to reduce the number of pins on the interface connector.

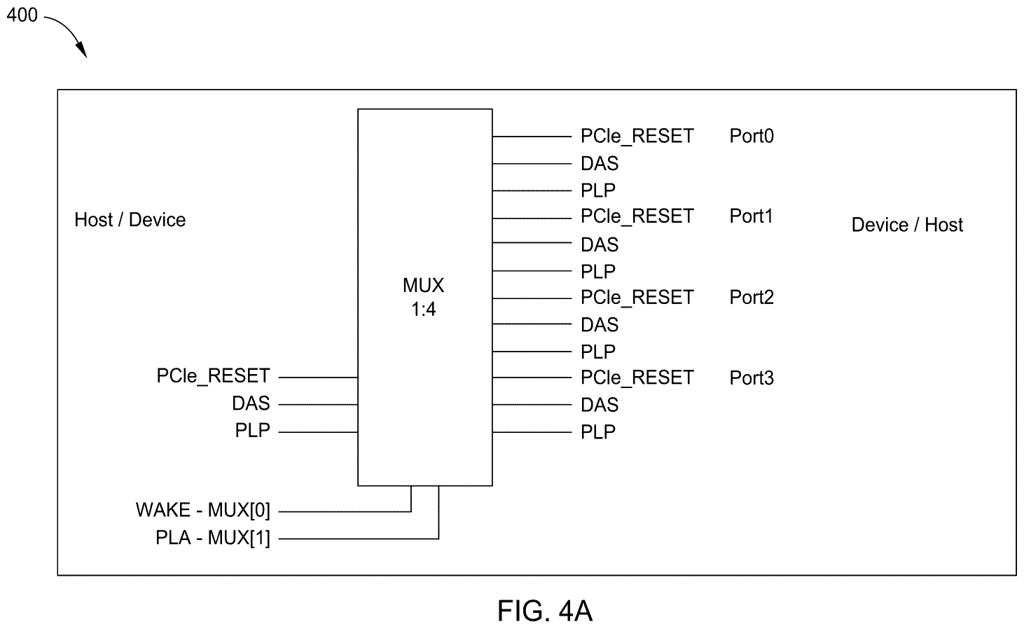

FIG. 4A is a schematic illustration of a time division multiplexing scheme used for PCIe sideband signals in a multi-port storage device according to one embodiment. The signaling and controlling that the multiplexer (mux) performs is by current existing sideband signals that are not used such as the WAKE or PLA signals shown in FIG. 4A or vendor specific pin signals that are already with the PCIe that can be reused. There are already pins accounted for on the interface and whatever pins that are defined as redundant will be reused. Note that the mux from FIG. 4A may be on the host device side or the data storage device side or on both such that a mux/demux is present with the mux on the host device side and the demux on the data storage device side.

As shown in FIG. 4A, the system 400 has a mux with two sideband signal lines (i.e., WAKE, PLA) coupled thereto. Hence, there are pins on the mux for the signal lines. Additionally, there are three input signals shown (i.e., PCIe_Reset, device activity signal (DAS), and power loss prevention (PLP)). Hence, there are pins on the mux for each input signal. Each port has the three corresponding input signals output thereto as output signals (i.e., PCIe_Reset, DAS, and PLP). Hence, there are pins on the mux for each output signal.

FIG. 4B is a schematic illustration of a time division multiplexing scheme used for PCIe sideband signals in a multi-port storage device according to another embodiment. The system 450 shown in FIG. 4B includes a mux 452 that has numerous pins. Pins 454 are signal input pins. There are input signal lines 460 shown coupled thereto. While there are three pins 454 and lines 460 shown, it is to be understood that there could be more or less pins 454 and lines 460. Further, it is to be understood that the number of pins 454 may exceed the number of lines 460. Pins 456 are sideband signal pins and are shown to have sideband input signal lines 462 coupled thereto. While there are three pins 456 and lines 462 shown, it is to be understood that there could be more or less pins 456 and lines 462. Further, it is to be understood that the number of pins 456 may exceed the number of lines 462. Pins 458 are output signal pins that are shown to have output lines 464A-464N coupled thereto. Each grouping of lines 464A-464N is representative of output lines that would couple to ports. While there are three pins 458 and lines 464A-464N grouping shown, it is to be understood that there could be more or less pins 458 and lines 464A-464N. Further, it is to be understood that the number of pins 458 may exceed the number of lines 464A-464N. What is to be noted, however, is that the number of pins 456 for the sideband signals, in total, is less than the total number of pins 458 for output lines 464A-464N. There is, notably, not an equal number of sideband pins 456 for each output line 464A-464N. Rather, because the sideband signal is delivered to the mux 452 through pins 456, there is no need for output sideband pins for each output line 464A-464N such that the number of output sideband pins for each group of output lines 464A-464N would equal the number of pins 456. Instead, because of the mux, the sideband signal delivered through the pins 456 is reused for, or more specifically multiplexed to, each set of lines 464A-464N to deliver to a respective port in the multi-port device.

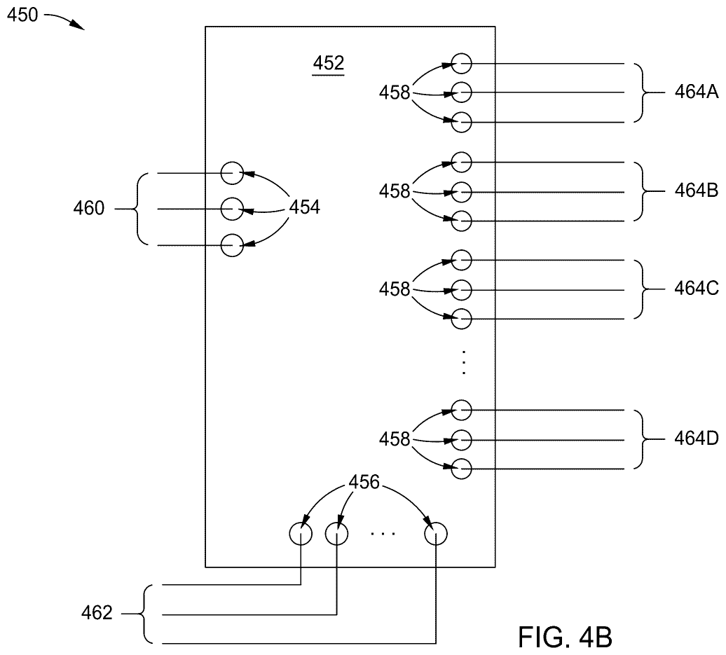

An alternative approach to multi-port storage multitude of side band signals is to use the system management bus (SMBus) interface and virtualize all the existing PCIe side-band signals over serial interface. The SMBus interface exposes a serial interface with address and command protocol, as well as dynamic mastership and a means to send interrupt signaling, whether a hard input/output (IO) signal or in-band interrupts. In this scenario, all of the sideband signaling is simply thrown away and abstracted over the SMBus by virtualization. FIG. 5 is a schematic illustration of a SMBus interface used for PCIe sideband signals in a multi-port storage device according to one embodiment. As shown in FIG. 5, the system 500 includes, on the host device side, numerous host ports and corresponding PCIe ports on the device controller side with an interface/bus therebetween. Data can pass between the respective host and device ports. Sideband signals are redundant and are instead controlled via a SMBus controller using firmware or a dedicated hardware engine. The sideband signals that are received through the SMBus controller of the device controller are virtualized to the respective PCIe ports in the device controller.

It should be noted that with the embodiments of the disclosure, an element will now be acting as a master, controlling the different hosts that intend to use the storage device via the side band. The element may reside in an intermediate layer, or on the host side.

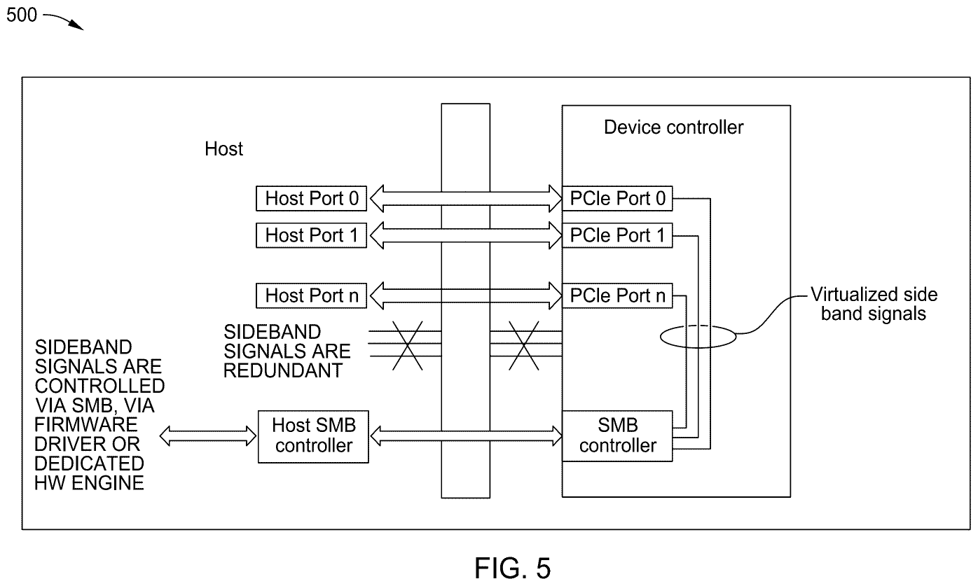

FIG. 6 is a schematic illustration of a system 600 incorporating the embodiments of the disclosure. System 600 includes a host device 602 and a data storage device 604. Within the host device is a signal element 606 for delivering signals to the data storage device 604. In one embodiment, the signal element 606 may be a mux. In another embodiment, the signal element 606 may be a host device SMBus controller. The data storage device 604 includes a signal receiving element 608. In one embodiment, the signal receiving element 608 may be a mux. In another embodiment, the signal receiving element 608 may be a demux. In another embodiment, the signal receiving element 608 may be a data storage device SMBus controller.

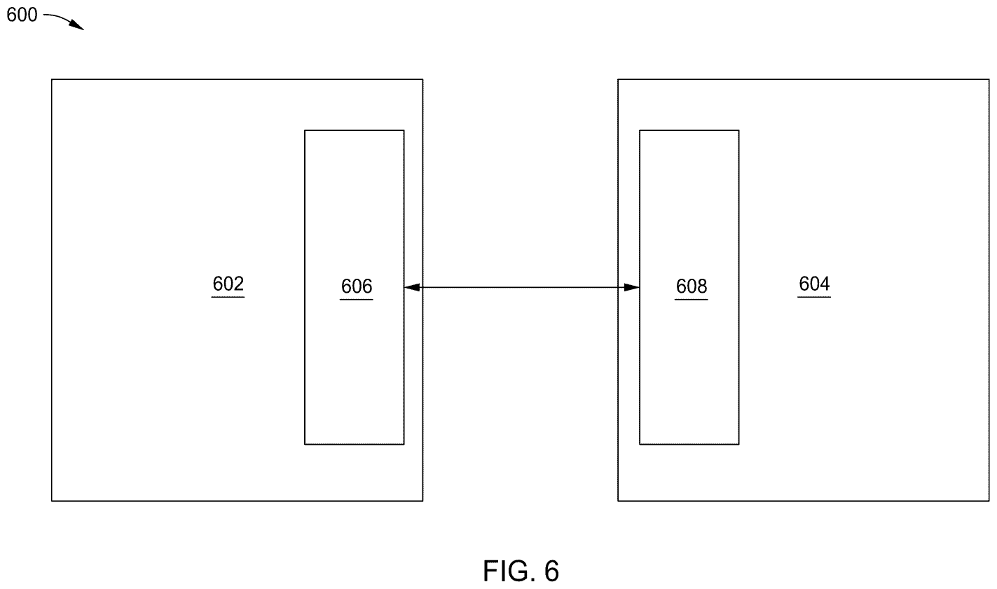

FIG. 7 is a flowchart 700 showing a method of delivering sideband signals according to one embodiment. In FIG. 7, a sideband signal is received at a mux at block 702. In one embodiment, the sideband signal is received at a demux. The sideband signal is then delivered to a first port of a multi-port device at block 704. In one embodiment, the multi-port device is a data storage device. In another embodiment, the multi-port device is a memory device of a data storage device. The sideband signal is then reused at block 706 to provide the same sideband signal from block 704 to a different port of the multi-port device. In one embodiment, blocks 704 and 706 occur simultaneously. In another embodiment, blocks 704 and 706 occur consecutively, in any order. Regardless, the sideband signal received at block 702 is multiplexed in the mux so as to avoid the use of additional pins for each port.

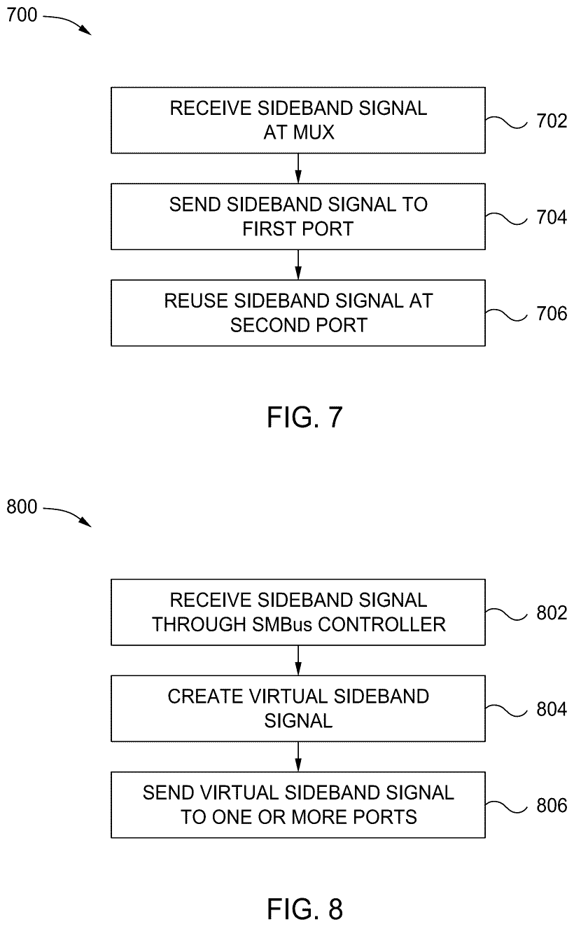

FIG. 8 is a flowchart 800 showing a method of delivering sideband signals according to another embodiment. At block 802, the sideband signals are received through a SMBus controller. Then, at block 804, virtual sideband signals are created at the SMBus controller and delivered to one or more ports of the multi-port device at block 806. In one embodiment, the multi-port device is a data storage device. In another embodiment, the multi-port device is a memory device of a data storage device. Due to the use of SMBus, virtual sideband signals can be used which necessitates the use of less storage space for pins for delivering sideband signals to ports in a multi-port device.

The main advantage of the embodiments discussed herein is reducing the interface number of pins and wires which is extremely important for example in automotive industry. The approach will also reduce the BOM cost.

In one embodiment, a data storage device comprises: a plurality of memory devices; and a controller coupled to each memory device, wherein the controller comprises: a first plurality of control signal input pins; a second plurality of control signal output pins; and a third plurality of sideband signal input pins, wherein the third plurality is less than the second plurality. The second plurality is greater than the first plurality. The pins are disposed on a multiplexer (mux). The mux is a time division mux. The pins are disposed on a de-multiplexer (demux). At least one sideband signal input pin of the third plurality of sideband signal input pins is a vendor specific sideband signal input pin. At least one sideband signal input pin of the third plurality of sideband signal input pins is a power loss acknowledge (PLA) input pin. At least one sideband signal input pin of the third plurality of sideband signal input pins is a wake pin. The controller is configured to deliver sideband signals from the third plurality of sideband signal input pins to each of the memory devices. Each memory device is coupled to the controller by a fourth plurality of signal lines that are each coupled to the second plurality of control signal output pins. The fourth plurality is equal to the first plurality.

In another embodiment, a data storage device comprises: a memory device; and a controller coupled to the memory device, wherein the controller comprises: a plurality of peripheral component express (PCIe) ports; and a system management bus (SMBus) controller, wherein the SMBus is configured to receive sideband signals from a host device, and wherein the SMBus is configured to provide virtualized sideband signals to each PCIe port of the plurality of PCIe ports. The plurality of PCIe ports are configured to not receive sideband signals directly from the host device. The controller comprises a serial interface. The sideband signals are controlled using a firmware driver.

In another embodiment, a data storage device comprises: means to store data; and a controller coupled to the means to store data, wherein the controller comprises: a time division multiplexer (mux) having “n” number of sideband pins, wherein “n” is an integer, and wherein the mux is configured to switch between 2ⁿ contexts for control signals for data storage device operation. The mux has a plurality of ports. The means to store data is coupled to the controller through the plurality of ports. The controller is configured to send sideband signals to the means to store data through a system management bus (SMBus) controller. “n” is greater than 1.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a plurality of memory devices; and
a controller coupled to each memory device, wherein the controller comprises:
a first plurality of control signal input pins;
a second plurality of control signal output pins; and
a third plurality of sideband signal input pins, wherein the third plurality is less than the second plurality.

2. The data storage device of claim 1, wherein the second plurality is greater than the first plurality.

3. The data storage device of claim 1, wherein the pins are disposed on a multiplexer (mux).

4. The data storage device of claim 3, wherein the mux is a time division mux.

5. The data storage device of claim 1, wherein the pins are disposed on a de-multiplexer (demux).

6. The data storage device of claim 1, wherein at least one sideband signal input pin of the third plurality of sideband signal input pins is a vendor specific sideband signal input pin.

7. The data storage device of claim 1, wherein at least one sideband signal input pin of the third plurality of sideband signal input pins is a power loss acknowledge (PLA) input pin.

8. The data storage device of claim 1, at least one sideband signal input pin of the third plurality of sideband signal input pins is a wake pin.

9. The data storage device of claim 1, wherein the controller is configured to deliver sideband signals from the third plurality of sideband signal input pins to each of the memory devices.

10. The data storage device of claim 1, wherein each memory device is coupled to the controller by a fourth plurality of signal lines that are each coupled to the second plurality of control signal output pins.

11. The data storage device of claim 10, wherein the fourth plurality is equal to the first plurality.

12. A data storage device, comprising:
a memory device; and
a controller coupled to the memory device, wherein the controller comprises:
a plurality of peripheral component express (PCIe) ports; and
a system management bus (SMBus) controller, wherein the SMBus is configured to receive sideband signals from a host device, and wherein the SMBus is configured to provide virtualized sideband signals to each PCIe port of the plurality of PCIe ports.

13. The data storage device of claim 12, wherein the plurality of PCIe ports are configured to not receive sideband signals directly from the host device.

14. The data storage device of claim 12, wherein the controller comprises a serial interface.

15. The data storage device of claim 12, wherein the sideband signals are controlled using a firmware driver.

16. A data storage device, comprising:
means to store data; and
a controller coupled to the means to store data, wherein the controller comprises:
a time division multiplexer (mux) having “n” number of sideband pins, wherein “n” is an integer, and wherein the mux is configured to switch between 2ⁿ contexts for control signals for data storage device operation.

17. The data storage device of claim 16, wherein the mux has a plurality of ports.

18. The data storage device of claim 17, wherein the means to store data is coupled to the controller through the plurality of ports.

19. The data storage device of claim 16, wherein the controller is configured to send sideband signals to the means to store data through a system management bus (SMBus) controller.

20. The data storage device of claim 16, wherein “n” is greater than 1.
